(19) United States
(12) Patent Application Publication
(10) Pub. No.: US 2006/0126808 A1
(43) Pub. Date: Jun. 15, 2006

(54) System and method for measurement of call deflection

(75) Inventors: Lona Noelle Dallessandro, Austin, TX (US); Adam Lee Klein, Cedar Park, TX (US); Marc Andrew Sullivan, Austin, TX (US); Wesley McAfee, Cedar Park, TX (US); Charles Scott, Austin, TX (US); Donn Wilburn JR., Seagoville, TX (US); Olivia Jennine Gomez, San Antonio, TX (US); Shatadru Chowdhury, Fremont, CA (US); Alvin Daluyaya, Danville, CA (US); Sreenivas Konduru, Mountain View, CA (US); Lidiya Demicheva, Pacifica, CA (US)

Correspondence Address: TOLER SCHAFFER, LLP, 5000 PLAZA ON THE LAKES, SUITE 265, AUSTIN, TX, 78746, US

(73) Assignee: SBC Knowledge Ventures, L.P.

(21) Appl. No.: 10/920,719

(22) Filed: Dec. 13, 2004

(51) Int. Cl. H04M 15/00

(52) U.S. Cl. 379/133

(57) ABSTRACT

The disclosure is directed to a method of providing computer assisted user support to a computer user. The method includes collecting customer identification information for a user of a computer assisted user support tool. The method further includes collecting trouble report information in response to use of the computer assisted user support tool. The trouble report information is associated with a particular class of reportable trouble items. In addition, the method includes comparing the customer identification information and the trouble report information to a data log of a customer support call center.

### FIELD OF THE DISCLOSURE

This disclosure, in general relates to systems and methods for measurement of call deflection.

### BACKGROUND

Traditionally, customer support for technical issues has been performed using technical support call centers. When a customer has a technical issue or trouble with a technology related product, such as high-speed Internet access or a software product, the customer calls the call center to discuss the trouble with a call center agent. However, operation of technical support call centers is expensive.

Technical support call center agents are generally experienced and competent in technology related fields. As such, technical support agents demand higher wages than the average call center agent. In addition, technical support agents undergo expensive training relating to the technology products they support, increasing agent costs.

To reduce costs associated with technical support call centers, some companies have attempted to move technical support call centers to countries with lower labor costs. However, foreign call centers incur increased expenses relating to communication traffic. In addition, companies typically find a shortage in competent and trained agents in the foreign location.

For both regional and foreign call centers, increased usage by customers leads to further increased costs. High call volume leads to high labor costs for regional call centers and high communications traffic and logistics problems for foreign call centers.

For some products, such as high-speed Internet connections and software products, companies have developed automated self-help software in an effort to reduce call volume. However, these self-help support tools typically do not provide metrics or measurements as to their effectiveness. Therefore, there is a need for improved systems and methods for providing automated self-help software and for measuring the effectiveness of using such tools.

### BRIEF DESCRIPTION OF THE DRAWINGS

FIGS. 1 and 2 are block diagrams illustrating exemplary embodiments of customer support systems.

FIGS. 3, 4, and 5 are flow diagrams illustrating exemplary methods of operation of customer support systems such as those illustrated in FIGS. 1 and 2.

### DESCRIPTION OF THE DRAWING(S)

In a particular embodiment, the disclosure is directed to a method of providing computer assisted user support to a computer user. The method includes collecting customer identification information for a user of a computer assisted user support tool. The method further includes collecting trouble report information in response to use of the computer assisted user support tool. The trouble report information is associated with a particular class of reportable trouble items. In addition, the method includes comparing the customer identification information and the trouble report information to a data log of a customer support call center.

In another exemplary embodiment, the disclosure is directed to a method of measuring call deflections from use of a computer self-help tool. The method includes collecting data from a computer self-help tool. The data includes a customer identifier, a reported trouble issue, and a resolution action for the reported trouble issue. The method also includes comparing the data from the computer self-help tool to a call center data log to determine whether the customer called the call center for support with respect to the reported trouble issue or whether the call was deflected by use of the computer self-help tool. Measurement data with respect to a result of comparing the call center data log and the data from the computer self-help tool is recorded.

In a further exemplary embodiment, the disclosure is directed to computer systems having a computer readable memory wherein the computer readable memory includes software instructions operable to perform the methods described above.

In another exemplary embodiment, the disclosure is directed to a computer system including a self-help tool server configured to receive customer identification information from a self help tool, a call center management system configured to receive telephone call information, and a data warehouse system configured to receive the customer identification information and configured to receive the telephone call information. The customer identification information and the telephone call information are accessible via the data warehouse for determining effectiveness of the self-help tool.

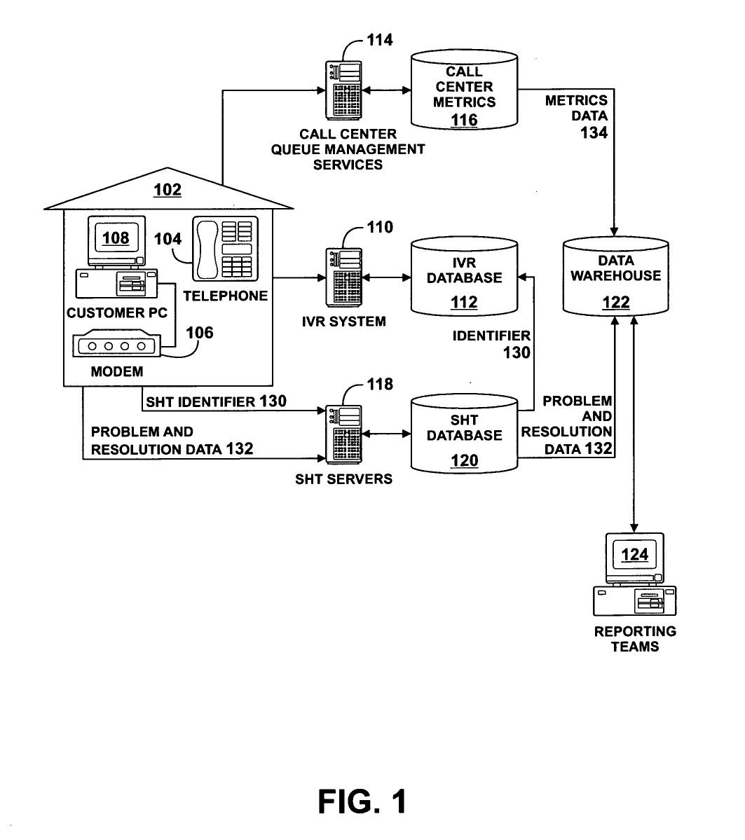

An illustrative system is depicted in FIG. 1. A customer located at a customer location 102 may have on premise equipment, such as a telephone 104 and a computer 108 coupled to a data transport technology, such as a modem 106, for example, a digital subscriber line (DSL) modem. The customer may, for example, install a computer software self-help and diagnostics tool on the computer 108. Once installed, the self-help and diagnostics tool communicates an SHT identifier 130, such as a telephone number of the customer, via the modem 106 to a self-help tool (SHT) server 118. The SHT server 118 stores the customer's telephone number in a SHT database 120. In alternative embodiments, the SHT identifier 130 can be a unique customer identifier, such as an account number, member identifier or telephone number.

The SHT identifier stored in the SHT database 120 is transferred to an interactive voice response (IVR) system 110 and stored in an IVR database 112. For example, telephone numbers may be transferred as received, periodically (i.e. hourly or nightly), or during off-peak times (i.e. at night).

When the customer experiences a problem, the customer may use the self-help tool (SHT) installed on the computer 108. For example, the computer software SHT may launch automatically in response to detecting a problem. Alternatively, the computer software SHT may be initiated by a user of the computer 108. If the problem is resolved by the computer software SHT, information about the problem and resolution of the problem 132 is sent to the SHT server 118 and stored on the SHT database 120. Information about failure to solve a problem 132 may also be transferred and stored on the SHT database 120. Data associated with resolution of customer problems, such as SHT problem resolution metrics, are reported to a data warehouse 122. When a problem has been resolved by the SHT and the customer does not call a call center, the call has been deflected, reducing the number of calls the call center receives.

If a customer calls a call center for support, the customer may first interact with an interactive voice response (IVR) system 110. The IVR system 110 receives customer identification information, such as DSL telephone number information, and compares the information to SHT identifiers, such as the DSL telephone numbers previously stored in the IVR database 112. The IVR directs the call based on whether the customer has an installed and operational SHT. For example, if the IVR determines, based on finding the customer's DSL telephone number in a list of stored DSL telephone numbers, that the customer has an installed and operational SHT, the system may direct the call to an SHT supporting agent or may direct the troubleshooting flow to be followed by the agent. For example, the call may be sent to a call center queue management server 114 with an indication that an SHT is installed on the customer's computer.

Based on the customer's identification and response to menu options and queries, the customer may be transferred to a call center queue management server 114 to await interaction with a call center agent. Information associated with the customer's call, such as the DSL telephone number, reason for the call, and resolution data, may be stored in a call center metrics database 116.

The call center metrics database 116 transfers data 134, such as the DSL telephone numbers, to the data warehouse 122 for storage. Reporting teams may access the data warehouse 122 via a reporting team interface 124. The data warehouse 122, which includes data received from the SHT database 120 and data received from the call center metrics database 116, may be used to analyze and report effectiveness of the computer software SHT. For example, the reporting team interface 124 may determine efficiency of the SHT, a return on investment (ROI) based on a number of measured deflected calls, and future problem resolutions that may be implemented in subsequent versions of the computer software SHT. In one exemplary embodiment, the reporting team interface 124 may compare DSL telephone numbers of customers calling into the call center with the DSL telephone numbers of customers running the computer software SHT to determine an efficiency of the SHT or the ROI of the SHT.

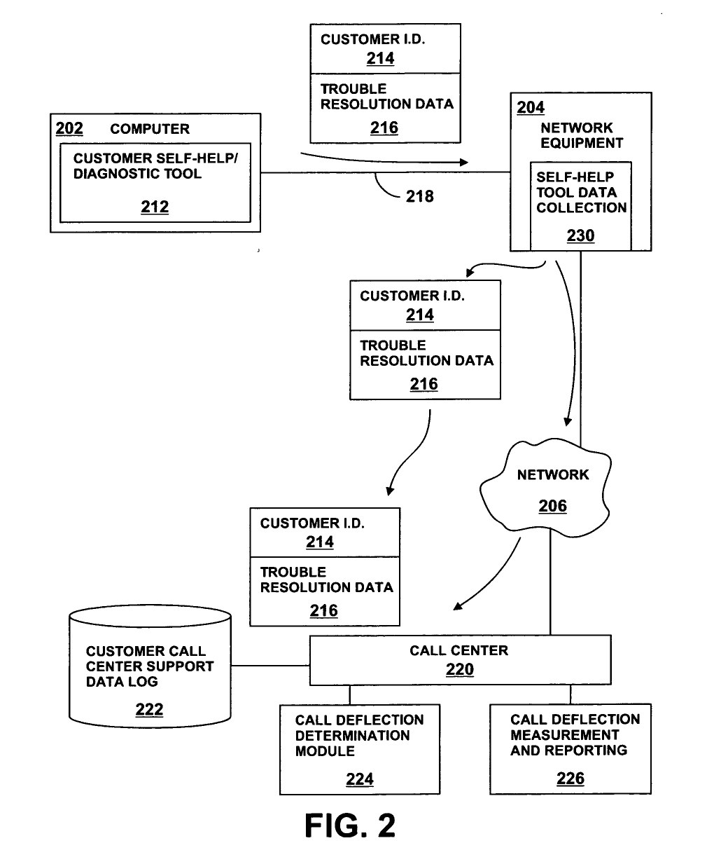

Referring to FIG. 2, an illustrative system is shown. The system includes a representative end user computer 202 coupled via a data connection 218 to network equipment 204. The system further includes a call center 220 coupled to the network equipment 204 via an intermediate computer network 206. The call center 220 is coupled to a customer call center support data log 222, a call deflection determination module 224, and a call deflection measurement and reporting module 226. The end computer 202 includes a customer self-help support and diagnostic software tool 212.

During operation, a user of the computer 202 executes the customer self-help and diagnostic software tool 212 and generates trouble resolution data 216. In addition, the computer 202 retrieves information as to the user identity and creates a data item referred to as a customer ID 214. After use of the self-help support tool, the customer ID 214 and the trouble resolution data 216 are communicated over the data connection 218, such as a digital subscriber line (DSL) connection, to the network equipment 204. The network equipment 204 retrieves the customer ID 214 and trouble resolution data 216 from the computer 202 as well as other data that may be received at the network equipment and all data provided by the self-help tool is stored at the self-help tool data collection module 230. The network equipment 204 communicates the customer ID 214 and the trouble resolution data 216 over a distributive network 206, such as the Internet or a private distributive computer network, to the remotely located call center 220.

The call center 220 stores the customer ID 214 and trouble resolution data 216. A call deflection determination module 224 receives the stored customer ID 214 and trouble resolution data 216 and compares such data with call records stored within the customer call center support data log 222. The call deflection determination module 224, based on the comparison, generates a determination as to the number and identity of potential call center calls that have been deflected through use of the self-help and diagnostic tool. For example, based on a particular type of trouble item and based on a customer ID, the call deflection determination module checks the call center 220 to determine whether a customer having the caller ID places a call with a specified time frame to the call center. If no call is detected, that resolution actions taken by the SHT are tracked as a successful call deflection. The call deflection determination module 224 generates call deflection data and provides such call deflection information to the call deflection measurement and reporting unit 226. The call deflection measurement and reporting module 226 performs cost measurements and other data measurements to create and display call deflection reports for operations personnel to evaluate call deflection metrics and performance.

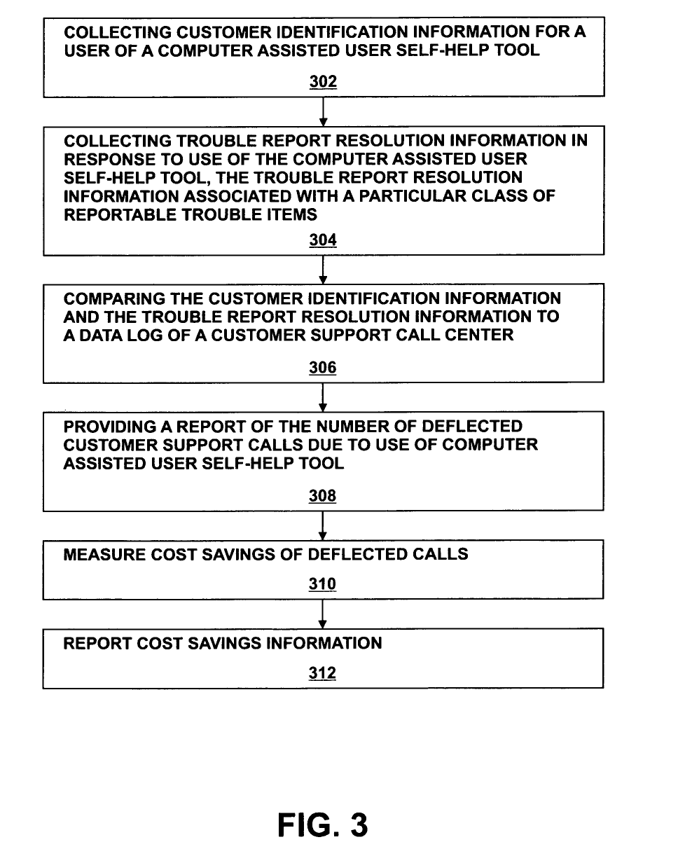

Referring to FIG. 3, a method of operation with respect to the illustrative call centers and related systems of FIGS. 1 and 2 is shown. The method includes collecting customer identification information for a user of a computer-assisted user support tool, as shown at step 302. The method further includes collecting trouble report resolution information in response to use of the computer assisted user support tool, as shown at step 304. The trouble report resolution information may be associated with a particular class of reportable trouble items. As shown at step 306, the customer identification information and the trouble report resolution information are compared to a data log of call records retrieved from a customer support call center. A report of a number of deflected customer support calls through successful use of the computer assisted user support tool is provided, as shown at step 308. Cost savings based on the number of deflected calls is measured, as shown at step 310, and a report including the deflected call count and measured call center cost savings information is reported, as shown at step 312. The report may be generated locally or may be distributed over a network for remote access and display.

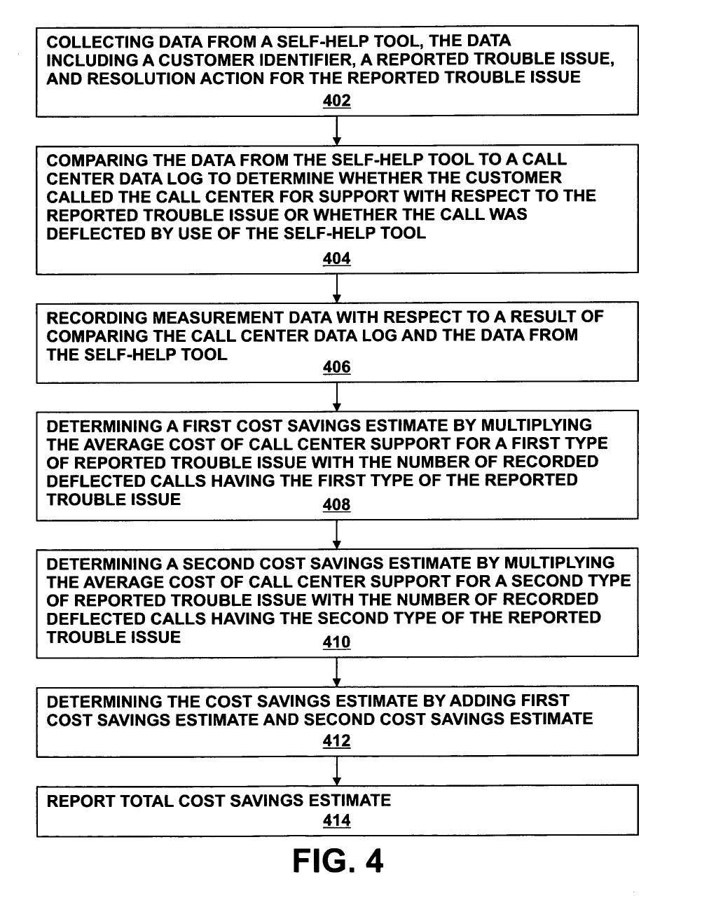

Referring to FIG. 4, a method of evaluating performance of a computer self-help tool is shown. The method includes collecting data that includes a customer identifier, a reported trouble issue, and resolution action for the reported trouble issue, as shown at 402. The method further includes comparing the data from computer self-help tool to a call center data log to determine whether the customer called the call center for support with respect to a reported trouble issue corresponding to the issue handled using the self-help tool, or whether the call was successfully deflected by the customer's use of the self-help tool, as shown at step 404. The method further includes recording measurement data with respect to the result of comparing the call center data log and the data from the self-help tool, as shown at step 406. After the measurement data from the comparison has been recorded, a first cost savings estimate is determined based on the average cost of call center support for the first type of reported trouble issue multiplied by the number of deflected calls having the first type of trouble issue, as shown at step 408. The method further includes determining a second cost savings estimate by multiplying the average cost of call center support for a second type of reported trouble issue with a number of recorded deflected calls having the second type of reported trouble issue, as shown at step 410. An example of the first trouble issue would be an email problem and an example of the second trouble issue class would be a broadband network connectivity failure. The method further includes determining a total cost savings estimate by adding the first cost savings estimate and the second cost savings estimate, as shown at 312. Additional types of reported trouble items and the associated cost savings for calls deflected with those trouble items may also be added to the total cost savings estimate. A report then may be generated to display the total cost savings estimate, as shown at step 414.

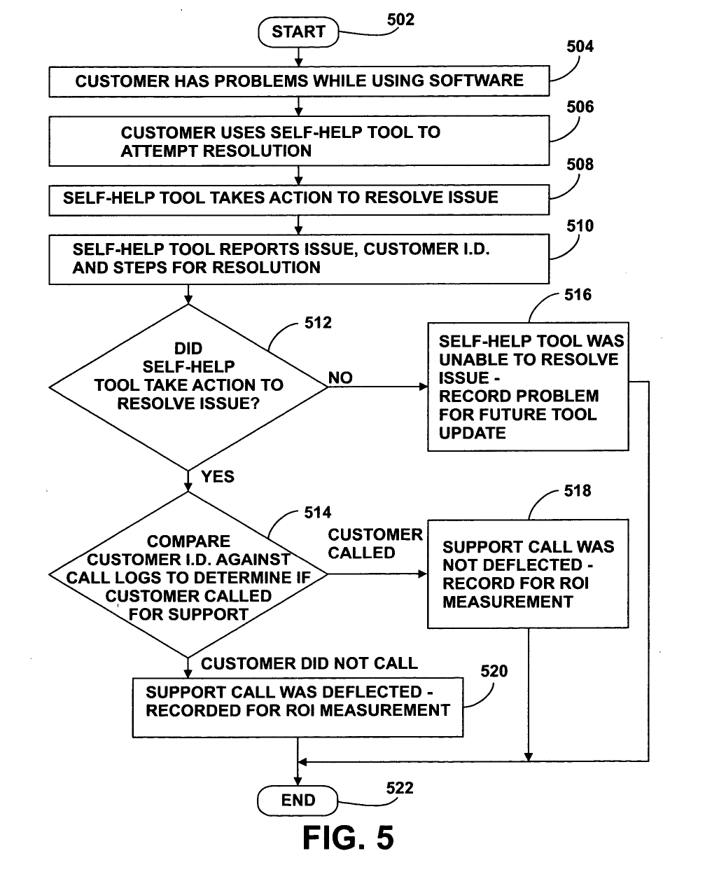

Referring to FIG. 5, a method of identifying and tracking call deflection from use of a computer self-help tool is shown. The method starts, as shown at step 502, and proceeds to step 504 where a customer has a problem while using a particular software program. The customer uses a self-help computer software tool to attempt resolution of the problem, as shown at step 506, and the self-help computer software tool takes an action to resolve the problem, as shown at step 508. The self-help computer software tool reports the trouble issue, a customer identification, and the steps taken for resolution of the reported problem, as shown at step 510.

At decision step 512, it is determined whether the self-help computer software tool acted to resolve the particular reported trouble issue. If the self-help tool acted to resolve the trouble issue then processing proceeds to decision step 514. Where the self-help software tool did not act to support the problem, the method proceeds to step 516, where data is collected to indicate that the tool was unable to resolve the trouble issue, and the problem is recorded for a future tool update. Processing ends at 522.

Referring back to decision step 514, the customer ID is compared against call log data from a call center to determine if the customer called for agent support. If the customer called for support, the support call was not deflected and the lack of call deflection is recorded for return on investment measurement information, as shown at step 514, and processing ends, as shown at step 522. In the case where the customer did not call for support, then the customer call was successfully deflected and the call deflection is recorded for measurement purposes, as shown at step 520. The method ends, as shown at step 522.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing computer assisted user support to a computer user, the method comprising:
collecting customer identification information for a user of a computer assisted user support tool;
collecting trouble report information in response to use of the computer assisted user support tool, the trouble report information associated with a particular class of reportable trouble items;
comparing the customer identification information and the trouble report information to a data log of a customer support call center.

2. The method of claim 1, further comprising determining and storing call deflection data based on the comparison of the customer support call center data log with the collected customer identification information and the trouble report information.

3. The method of claim 1, wherein the particular class of reportable trouble items is related to lack of network connectivity.

4. The method of claim 1, wherein the particular class of reportable trouble items is related to email problems.

5. The method of claim 1, wherein the computer assisted user support tool is a self-help software tool provided in connection with a communication service.

6. The method of claim 5, wherein the communication service is a digital subscriber line (DSL) service.

7. The method of claim 1, further comprising providing a report of the number of support calls to the customer support call center that were deflected as a result of use of the computer assisted user support tool.

8. The method of claim 7, further comprising determining a measurement of cost savings resulting from use of the computer assisted user support tool based on the number of deflected customer support calls.

9. A method of measuring call deflections from use of a computer self-help tool, the method comprising:
collecting data from the computer self-help tool, the data including a customer identifier, a reported trouble issue, and a resolution action for the reported trouble issue;
comparing the data from the computer self-help tool to a call center data log to determine whether the customer called the call center for support with respect to the reported trouble issue or whether the call was deflected by use of the computer self-help tool; and
recording measurement data with respect to a result of comparing the call center data log and the data from the computer self-help tool.

10. The method of claim 9, further comprising determining a first cost savings estimate by multiplying the average cost of call center support for a first type of reported trouble issue with the number of recorded deflected calls having the first type of the reported trouble issue.

11. The method of claim 10, further comprising determining a second cost savings estimate by multiplying the average cost of call center support for a second type of reported trouble issue with the number of recorded deflected calls having the second type of the reported trouble issue.

12. The method of claim 11, further comprising adding the first cost savings estimate and the second cost savings estimate to provide a total cost savings estimate.

13. The method of claim 9, wherein the call center data log is limited to a particular set of data corresponding to calls received within a selected time frame.

14. The method of claim 13, wherein the selected time frame is less than one month.

15. The method of claim 11, wherein the first type of reported trouble issue relates to internet connectivity and the second type of reported trouble issue relates to email.

16. The method of claim 9, wherein the customer identifier is a telephone number.

17. The method of claim 9, wherein the computer self-help tool is a self-help software tool provided in connection with a communication service.

18. The method of claim 17, wherein the communication service is a broadband data communication service.

19. A computer system having a computer readable memory, the computer readable memory including software instructions operable to perform the method comprising:
collecting customer identification information for a user of a computer assisted user support tool;
collecting trouble report information in response to use of the computer assisted user support tool, the trouble report information associated with a particular class of reportable trouble items; and
comparing the customer identification information and the trouble report information to a data log of a customer support call center.

20. A computer system having a computer readable memory, the computer readable memory including software instructions operable to perform the method comprising:
collecting data from a computer self-help tool, the data including a customer identifier, a reported trouble issue, and a resolution action for the reported trouble issue;
comparing the data from the computer self-help tool to a call center data log to determine whether the customer called the call center for support with respect to the reported trouble issue or whether the call was deflected by use of the computer self-help tool; and
recording measurement data with respect to a result of comparing the call center data log and the data from the computer self-help tool.

21. A computer system comprising:
a self help software server configured to receive customer identification information from a self help software;
a call center management system configured to receive telephone call information associated with a customer support call; and
a data warehouse system configured to receive the customer identification information and configured to receive the telephone call information, wherein the customer identification information and the telephone call information are accessible for determining effectiveness of the self help software via an interface configured to access the data warehouse.

22. The computer system of claim 21, further comprising a self help software database accessible to the self help software server and configured to store the customer identification information.

23. The computer system of claim 21, wherein the self help software server is configured to receive trouble issue data from the self help software.

24. The computer system of claim 23, wherein the call center management system is configured to receive the customer identification information and the trouble issue data.

25. The computer system of claim 24, wherein the call center management system is configured to compare the telephone call information to the trouble issue data to determine whether the customer support call is associated with a trouble issue identified to the self help software.

26. The computer system of claim 21, further comprising a reporting system configured to access the data warehouse system and configured to display measurement data associated with the effectiveness of the self help software.
